(19) United States
(12) Patent Application Publication
(10) Pub. No.: US 2026/0330981 A1
(43) Pub. Date: Oct. 22, 2026

(54) CLOUD-SERVER DRIVEN REAL-TIME WIND MODELLING FOR IMPROVED FLIGHT MANAGEMENT SYSTEM PREDICTION ACCURACY

(71) Applicant: Honeywell International Inc., Charlotte, NC (US)

(72) Inventors: Subash Samuthirapandian, Bangalore (IN); Mahesh Sivaratri, Bangalore (IN); Ravish Udupa, Bangalore (IN); Murthy Sriram, Bangalore (IN)

(21) Appl. No.: 19/266,009

(22) Filed: Jul. 10, 2025

(30) Foreign Application Priority Data
Apr. 17, 2025 (IN) 202511037248

(51) Int. Cl. G08G 5/34; G01W 1/10; G08G 5/26

(52) U.S. Cl. CPC G08G 5/34; G01W 1/10; G08G 5/26

(57) ABSTRACT

A computing system onboard an aircraft is configured to receive, from one or more sensors of the aircraft, current sensed wind data; receive, from a first external data source, forecast wind data for a first set of points along a flight path defined by a flight plan; transmit at least a portion of the flight plan to a second external data source; in response to transmitting the at least the portion of the flight plan to the second external data source, receive, from the second external data source Automatic Dependent Surveillance-Broadcast (ADS-B)-acquired wind data for a second set of points along the flight path defined by the flight plan; and control the aircraft to follow the flight path defined by the flight plan based on the current sensed wind data, the forecast wind data, and the ADS-B-acquired wind data.

This application claims the benefit of Indian Provisional Patent Application No. 202511037248, filed Apr. 17, 2025, the entire contents of which are incorporated herein by reference.

### TECHNICAL FIELD

This disclosure relates to controlling a flight management system of an aircraft based on wind data.

### BACKGROUND

Vehicle operation and route planning technology, such as for aircrafts, increasingly relies on computer-based systems for obtaining current, most up-to-date data in order to determine an efficient and economical navigation plan. Vehicle operation and route planning technology also increasingly relies on computer-based systems to analyze past data in order to determine if a flight was flown in an efficient manner and to determine how operations can be improved. Such computation not only involves data captured and kept on-board the vehicle, but also involves data collected and analyzed off-board, such as by cloud-based analytics services.

### SUMMARY

This disclosure proposes an enhancement to the performance prediction of FMSs by enabling the acquisition of wind data through Automatic Dependent Surveillance-Broadcast (ADS-B)-In technology. Specifically, the ADS-B Out systems installed on neighboring aircraft are capable of transmitting ADS-B wind data for a specific location to ground stations, and the ground stations can transmit the ADS-B wind data back to other aircraft. The aircraft receiving the ADS-B wind data may then blend the ADS-B wind data with the ownship's sensed wind data. For example, an FMS may be configured to only use forecast wind data when ADS-B wind data is not available or to update the forecast wind data based on the ADS-B wind data. By controlling a flight path defined by a flight plan based on ADS-B-acquired wind data in addition to current sensed wind data and forecast wind data, systems of the present disclosure may enable an FMS to manage a flight plan based on more accurately predicted future wind encountered by the aircraft, thus resulting in improved flight-time estimates, timeliness, and fuel efficiency.

According to an example of this disclosure, a computer-implemented method for controlling an FMS of an aircraft according to a flight plan includes: determining, via one or more sensors of the aircraft, current sensed wind data; receiving, from a first external data source by processing circuitry of avionics of the aircraft, forecast wind data for a first set of points along a flight path defined by the flight plan; transmitting at least a portion of the flight plan to a second external data source; in response to transmitting the at least the portion of the flight plan to the second external data source, receiving, from the second external data source, ADS-B-acquired wind data for a second set of points along the flight path defined by the flight plan; and controlling, by the processing circuitry of the avionics, the aircraft to follow the flight path defined by the flight plan based on the current sensed wind data, the forecast wind data, and the ADS-B-acquired wind data.

According to an example of this disclosure, a computing system onboard an aircraft includes a memory and one or more processors coupled to the memory and configured to: receive, from one or more sensors of the aircraft, current sensed wind data; receive, from a first external data source, forecast wind data for a first set of points along a flight path defined by a flight plan; transmit at least a portion of the flight plan to a second external data source; in response to transmitting the at least the portion of the flight plan to the second external data source, receive, from the second external data source ADS-B-acquired wind data for a second set of points along the flight path defined by the flight plan; and control the aircraft to follow the flight path defined by the flight plan based on the current sensed wind data, the forecast wind data, and the ADS-B-acquired wind data.

According to an example of this disclosure, a computer-implemented method for acquiring and transmitting wind data includes: receiving, from a first aircraft via a message transmitted by the aircraft while in flight, wind data detected by the first aircraft at a location; updating a four-dimensional (4D) wind data buffer based on the wind data detected by the first aircraft at the location; receiving, from a second aircraft, flight plan data defining at least a portion of a flight path for the second aircraft; in response to the flight path for the second aircraft including the location, extracting from the 4D wind data buffer, the wind data detected by the first aircraft at the location; and transmitting the wind data detected by the first aircraft to the second aircraft.

According to an example of this disclosure, a system for acquiring and transmitting wind data to aircraft includes a memory and processing circuitry configured to receive, from a first aircraft via a message transmitted by the aircraft while in flight, wind data detected by the first aircraft at a location; update a 4D wind data buffer based on the wind data detected by the first aircraft at the location; receive, from a second aircraft, flight plan data defining at least a portion of a flight path for the second aircraft; in response to the flight path for the second aircraft including the location, extract from the 4D wind data buffer, the wind data detected by the first aircraft at the location; and transmit the wind data detected by the first aircraft to the second aircraft.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram showing an overview of an example computing environment in which techniques of the present disclosure may be implemented.

FIG. 2 shows an overview of an example aviation environment in which techniques of the present disclosure may be implemented.

FIG. 3 is a block diagram illustrating an example of a ground-based computing system in accordance with techniques of this disclosure.

FIG. 4 is a block diagram illustrating an example of a computing device for executing EFB applications in accordance with techniques of this disclosure.

FIG. 5 is a block diagram illustrating an example of an avionics system in accordance with techniques of this disclosure.

FIG. 6 is a flowchart illustrating a process for a computing system onboard an aircraft to control an FMS of an aircraft according to a flight plan.

FIG. 7 is a flowchart illustrating a process for a ground-based computing system to acquire and transmit wind data to and from aircraft.

Throughout the figures, like reference numerals across multiple figures refer to the same hardware, software, data, step, etc.

### DETAILED DESCRIPTION

The avionics of modern aircraft often include a flight management system (FMS) that can generate a flight plan and navigate an aircraft through the flight plan. A flight plan may, for example, include a departure location, destination location, a departure time, a desired arrival time, a desired flight duration, a desired altitude, a set of waypoints, an identification of weather structures to be avoided, a fuel load for the aircraft, a number of passengers on the aircraft, a desired speed, an identification of a runway, or other such flight-related information. Based on feedback from various navigation sensors on the aircraft, the FMS may ensure that the aircraft is adhering to the flight plan. In this regard, an FMS may be viewed as the custodian of the flight plan.

In order to assure timeliness for passengers, airlines need to accurately predict flight times and/or arrival times at destinations. In order to ensure efficiency and profitability, airlines need to be able to accurately predict fuel consumption, so as to minimize flying weight while still leaving ample reserves for unexpected situations. A lack of near-real-time wind data, including critical parameters such as wind speed and wind direction, make such predictions difficult. This deficiency may lead to inaccuracies in predictions regarding Estimated Time of Arrival (ETA), flight times, remaining fuel, predicted altitude, predicted speed, and other such flight parameters. These inaccuracies can adversely impact airport throughput and hinder passengers'ability to plan travel effectively, as the passengers cannot always rely on on-time arrivals at their destination airports.

Currently, FMSs permit pilots to input wind data manually into the flight plan and to utilize a datalink for wind information. However, neither process offers real-time or overly-precise wind data, which may be necessary for accurate FMS predictions, particularly with respect to predictions that are relatively far down-path of an aircraft's current location. Due to the unavailability of real-time wind data down path of the flight route, FMSs may use forecast wind data. In some implementations, FMSs may blend the current sensed wind data (sensed at a current aircraft position) with the forecast data linearly by washing out the current sensed wind data and mixing in the forecast wind data at a defined distance ahead of the aircraft and also at a defined altitude above or below the aircraft. Beyond these limits, forecasted wind data may be used. For example, at the current aircraft position, the current sensed wind data used may be 100% of the wind data for the FMS, while the forecast wind data is assumed to be 0% (i.e., not used). At a distance, farther away from the aircraft, the current sensed wind data may be used as 50% of the wind data for the FMS, while the forecast wind data is assumed to also be 50%. The current sensed wind data can be gradually washed out to 0% at beyond a specified configurable distance and altitude at which point the forecast wind data is used as 100% of the wind data for the FMS. Using higher percentages of the wind data determined from forecast wind data generally lessens the accuracy of FMS predictions because forecast wind data often times differs from the actual wind conditions. Due to this linear wash out algorithm for blending current sensed wind data with the forecast wind data, the accuracy of FMS performance predictions degrades down path of the flight trajectory.

For example, if an aircraft is going to experience a significant headwind during a later flight segment, then the most fuel efficient approach for maintaining timeliness of the flight may be for an FMS to slightly increase a current speed of the aircraft, such that the aircraft arrives at that flight segment sooner. If, however, the significant headwind is not detected until the aircraft actually arrives at that flight segment, then to maintain timeliness, the FMS may have to significantly increase engine thrust throughout that flight segment, which may be less fuel efficient, than a more prolonged but smaller increase in engine thrust. In another example, if an aircraft is going to experience a significant tailwind during a later flight segment, then the most fuel efficient approach for maintaining timeliness of the flight may be for an FMS to decrease a current speed of the aircraft, such that the aircraft arrives at that flight segment later but can still maintain a timely arrival due to the future tailwind.

In some examples, this disclosure proposes an enhancement to the performance prediction of FMSs by enabling the acquisition of wind data through ADS-B In technology. Specifically, the ADS-B Out systems installed on neighboring aircraft are capable of transmitting ADS-B wind data for a specific location to ground stations, and the ground stations can transmit the ADS-B wind data back to other aircraft. The aircraft receiving the ADS-B wind data may then blend the ADS-B wind data with the ownship's sensed wind data. For example, an FMS may be configured to only use forecast wind data when ADS-B wind data is not available or to update the forecast wind data based on the ADS-B wind data. By controlling a flight path defined by a flight plan based on ADS-B-acquired wind data in addition to current sensed wind data and forecast wind data, systems of the present disclosure may enable an FMS to manage a flight plan based on more accurately predicted future wind encountered by the aircraft, thus resulting in improved timeliness and fuel efficiency.

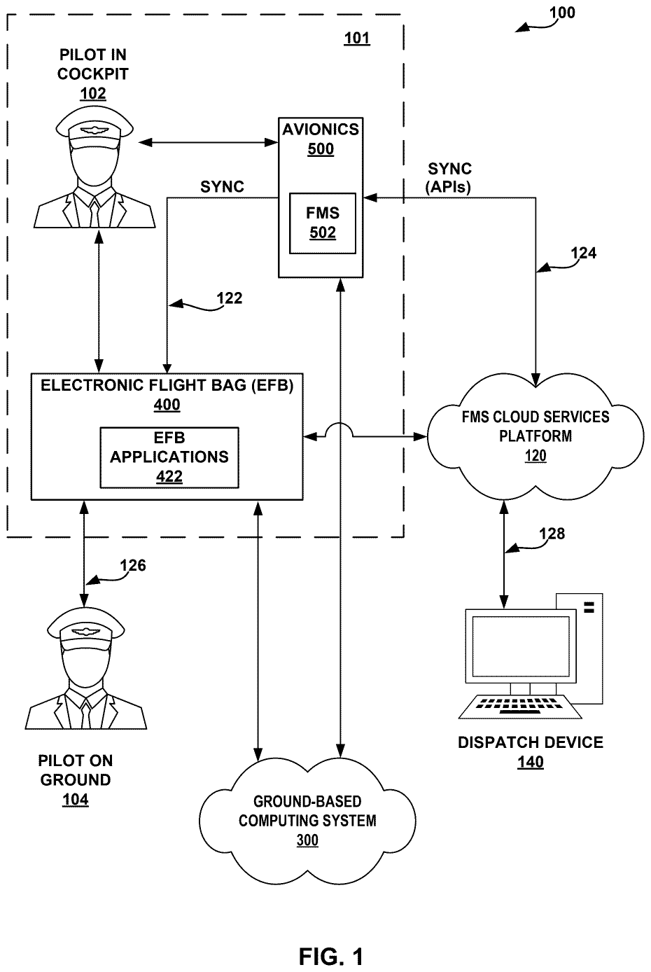

FIG. 1 shows an overview of an example computing environment 100, according to one or more examples of the present disclosure. In computing environment 100, EFB 400 is configured to communicate with avionics 500. EFB 400 and avionics 500 are both devices or systems that may be located inside aircraft 101. Computing environment 100 also includes a connected FMS cloud services platform 120 (platform 120) and a dispatcher device 140, which may be located outsider of aircraft 101, as well as ground-based computing system 300.

EFB 400 may be a computer device carried by a pilot or a flight crew, which may store, for example, navigational charts, maps for air and ground operations of an aircraft, a flight plan management system, an aircraft operating manual, flight-crew operating manual, software applications which automate flight-related or avionics-related computation tasks, and/or any application or data which may be installed in a general purpose computing platform. EFB 400 may include a pilot information display (PID).

Avionics 500 generally represents any electronic systems that may be implemented in an aircraft. Avionics 500 may, for example, perform functions related to communication, navigation, safety monitoring, and other such functionality. In the example show in FIG. 1, Avionics 500 includes FMS 502, which represents a specialized computer system and software configured to automate in-flight tasks according to a flight plan. Dispatcher device 140 may be any computer device which may be accessed by a user who performs planning, flying, navigating, or managing tasks associated with aircraft, airspaces, airports, or flight plans. Accordingly, the user is not limited to a dispatcher, and the dispatcher device 140 is not limited to a device of a dispatcher. The connected FMS cloud services platform 120 may be a cloud-based platform that provides FMS services to any user who has authorized access to the platform.

As shown in FIG. 1, computing environment 100 may accommodate access by various types of users. For example, a pilot 102, who may be in the cockpit of aircraft 101, may have access to EFB 400 and EFB applications 422 installed on EFB 400. Pilot 102 may also have access to avionics 500 and FMS 502, through which pilot 102 may access the connected FMS cloud services platform 120. EFB applications 422 may access connected FMS cloud services platform 120 and provide the FMS services to the users of EFB 400 in which the EFB applications 422 are installed. In that way, EFB 400 may provide user-friendly and customized user interfaces to pilot 102, by which pilot 102 may interact with FMS services from platform 120.

FMS 502 may also be configured to synchronize data 124 with connected FMS cloud services platform 120, using, for example, an application programming interface (API). In addition, FMS 502 may also be configured to synchronize data 122 with EFB applications 422. Thus, in some implementations, FMS 502 may be synchronized with data from both EFB 400 and platform 120 in real-time or at predetermined intervals, in such a way that the pilot 102 may rely on the on-board FMS 502 for all tasks arising in computing environment 100.

A pilot 104, who may be on the ground, may also access EFB 400 and the EFB applications 422. In some implementations, pilot 104 and pilot 102 may be the same pilot, yet under different circumstances (e.g., time and location of the access). Additionally, or alternatively, pilot 104 may be a different pilot than pilot 102, or another authorized member of the flight crew, who accesses EFB 400 on the ground for an official duty related to the connected FMS cloud services platform 120. While pilot 104 is accessing the EFB applications 422 via EFB 400, the EFB applications 422 may access the connected FMS cloud services platform 120 to receive various FMS services. In that way, EFB 400 may provide user-friendly and customized user interfaces, by which FMS services 126 from the connected FMS cloud services platform 120 may be serviced to pilot 104.

A dispatcher or other user may also access the connected FMS cloud services platform 120 through a dispatcher device 140. A dispatcher, in accordance with the present disclosure, may be any authorized personnel performing duties related to dispatching of aircraft in computing environment 100. For example, a dispatcher may be an airline staff, an airport staff, air traffic control personnel, a ground control personnel, a member of a relevant aviation authority, or any other authorized person who may benefit from FMS services from the connected FMS cloud services platform 120 in performing their duties. Dispatcher device 140 may be any computing device capable of establishing a connection 128 to the cloud and interfacing with the connected FMS cloud services platform 120. While the dispatcher is accessing the FMS services via the dispatcher device 140, the dispatcher device 140 may access the connected FMS cloud services platform 120 to receive various FMS services. In that way, the dispatcher device 140 may provide user-friendly and customized user interfaces, by which FMS services from the connected FMS cloud services platform 120 may be serviced to the dispatcher.

Among the various types of data that FMS cloud services platform 120 may provide to aircraft 101, platform 120 may transmit forecast wind data to FMS 502 prior to takeoff of aircraft 101. Platform 120 may, for example transmit forecast wind data to FMS 502 only for waypoints of a flight plan to be flown by aircraft 101. FMS cloud services platform 120 may transmit the forecast wind data directly to avionics 500 or may transmit the forecast wind data via an intermediary device, such as EFB 400. The forecast wind data may, for example, include predictions of wind direction and speed based on algorithms, models, historical weather patterns, and the like. Platform 120 may, for example, obtain the forecast wind data from a weather service, such as the U.S. National Weather Service, Federal Aviation Administration Weather Service, World Area Forecast System, or other such service. In other examples, the forecast wind data may be entered by a pilot prior to takeoff of the aircraft.

Ground-based computing system 300 may also be configured to transmit wind data aircraft 101 both pre-flight and in flight. For example, aircraft 101 may transmit at least a portion of a flight path being executed by FMS 502 to ground-based computing system, and in response, ground-based computing system 300 may transmit to aircraft 101, from a four-dimensional (4D) wind data buffer, wind data detected by other aircraft for a location along the flight path.

FMS 502, EFB 400, and dispatcher device 140 may include one or more devices capable of receiving, generating, storing, processing, and/or providing information associated with FMS services. For example, FMS 502, EFB 400, or the dispatcher device 140 may include a communication and/or computing device, such as a mobile phone (e.g., a smart phone, a radiotelephone, etc.), a computer (e.g., a desktop computer, a laptop computer, a tablet computer, a handheld computer), a gaming device, a wearable communication device (e.g., a smart wristwatch, a pair of smart eyeglasses, etc.), or a similar type of device.

As part of facilitating communication between any of avionics 500, EFB 400, or FMS cloud services platform 120, the systems and devices of this disclosure may be configured to transmit and receive flight plans in the form of a .RTE (route) file, a .FPL file, or other file formats. A .RTE file is a standard file format that may be used by FMS 502 and EFB applications 422 to store and exchange flight planning data. As will be illustrated in more detail below, .RTE files include some or all of sections for flight information, route details, altitude and speed information, fuel information, performance data, weather information, and other notes or remarks of interest to a pilot or other user. Each section then includes a field name and a value for the field name. A non-exhaustive list of fields that may be included in a .RTE file are FLIGHT_NUMBER, AIRCRAFT_TYPE, DEPARTURE_AIRPORT, DESTINATION_AIRPORT, ESTIMATED_DEPARTURE_TIME, ESTIMATED_ARRIVAL_TIME, WAYPOINTS, AIRWAYS, DEPARTURE_PROCEDURE, ARRIVAL_PROCEDURE, CRUISING_ALTITUDE, CLIMB_PROFILE, DESCENT_PROFILE, TOTAL_FUEL, TRIP_FUEL, RESERVE_FUEL, TAKEOFF_WEIGHT, LANDING_WEIGHT, ZERO_FUEL_WEIGHT, DEPARTURE_WEATHER, ARRIVAL_WEATHER, ENROUTE_WEATHER, PILOT_REMARKS, OPERATIONAL_NOTES.

Pilots (e.g., pilots 102 and 104) and dispatcher (e.g., a user of dispatch device 140) may use .RTE files to plan and file flight routes and ensure compliance with air traffic control and safety regulations. A .RTE file may be uploaded from EFB 400 to FMS 502 to provide necessary flight details for navigation and management during the flight. The interoperability of .RTE files may facilitate sharing of flight plans between different systems and stakeholders (e.g., airlines, airports, air traffic control). Instead of or in addition to .RTE files, FMS 502 and EFB applications 422 may exchange .FPL (flight plan) files, which include similar information as .RTE files and are used for similar purposes as .RTE files, but have a different formatting.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 (e.g., EFB 400 and dispatcher device 140) may be implemented within a single device, or a single device shown in FIG. 1 (e.g., EFB 400, FMS 502, or dispatcher device 140) may be implemented as multiple, distributed devices. Additionally, or alternatively, a set of devices (e.g., one or more devices) of computing environment 100 may perform one or more functions described as being performed by another set of devices of computing environment 100.

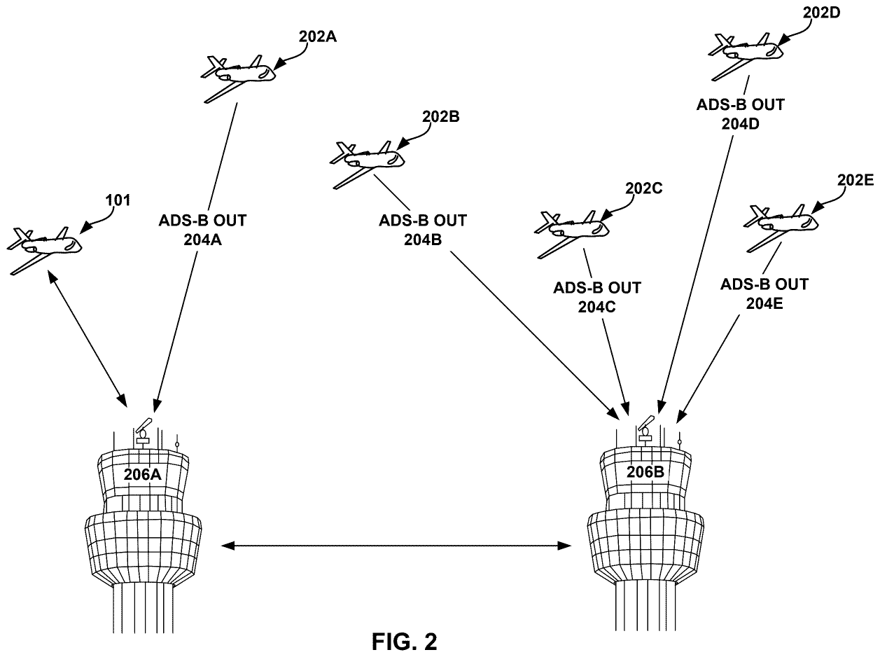

FIG. 2 shows an overview of an example aviation environment in which techniques of the present disclosure may be implemented. In the example of FIG. 2, aircraft 101 performs data communication with ground station 206A and 206B. Ground stations 206A and 206B may each host an instance of or a portion of ground-based computing system 300.

In the example of FIG. 2, aircraft 202A transmits ADS-B out message 204A to ground station 206A. ADS-B message 204A may include 4D wind data that indicates a wind speed and a wind direction associated with a latitude, a longitude, an altitude, and a time at which aircraft 202A acquired the wind speed and wind direction. Similarly, each of aircraft 202B, aircraft 202C, aircraft 202D, and aircraft 202E may respectively transmit ADS-B message 204B, ADS-B message 204C, ADS-B message 204D, and ADS-B message 204E with 4D wind data to ground station 206B. Although described as a single ADS-B message for purposes of explanation, it should be understood that any data described herein as being transmitted or received via an ADS-B message may also be transmitted or received as a plurality of ADS-B messages.

Each ADS-B message may, for example, include a message type and payload data. The message type may indicate the type of payload data. In one example, the ADS-B message may be a 112-bit message that includes a 5-bit type code indicating the type of data in the payload and 56 bits of payload. The remaining bits may be used for synchronization, error detection, and other such purposes. The 5-bit type code may for example, indicate that the ADS-B message includes aircraft identification information such as the aircraft's callsign, a surface position of the aircraft, an airborne position of the aircraft, an airborne velocity, or an emergency status of the aircraft.

Ground station 206A and ground station 206B may also share or aggregate their respective 4D wind data, either at ground station 206A or 206B or at a different location separate from ground station 206A or 206B, in a 4D wind data buffer. Aircraft 101 may then transmit a portion of a flight plan, including a flight path, to ground station 206A. Ground station 206A may then access the 4D wind data buffer to identify points along the flight path for which ADS-B-acquired 4D wind data is available and transmit that ADS-B-acquired 4D wind data to aircraft 101. FMS 502 of aircraft 101 may then control aircraft 101 based on the ADS-B-acquired 4D wind data either in addition to or in place of forecast wind data.

Ground stations 206A and 206B, as well as other ground stations, may continuously receive ADS-B reports from many aircraft operating within a reception range of the ground station. These ADS-B reports include real-time or sensed wind vectors along with their position which includes latitude, longitude, altitude, and time. Utilizing the real-time or sensed wind data obtained from the ADS-B reports, ground-based computing system 300 may construct a real-time 4D wind profile characterized by latitude, longitude, altitude, and time. Aircraft 101 may periodically transmit a flight plan trajectory so that ground-based computing system 300 can extract the relevant real-time or sensed wind data from the constructed 4D wind profile. Ground-based computing system 300 may then uplink the extracted wind profile corresponding to the flight plan trajectory of aircraft 101 to avionics 500, so that the real-time wind information can be used by FMS 502 to enhance prediction accuracy.

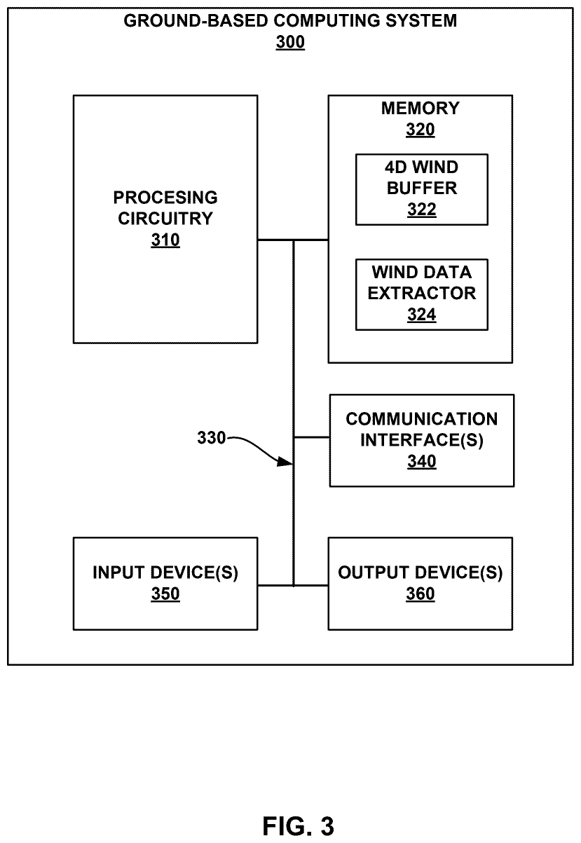

FIG. 3 is a block diagram illustrating an example of ground-based computing system 300. Ground-based computing system 300 may represent generic hardware (e.g., a general-purpose microprocessor) or specifically designed computing hardware (e.g., an application specific integrated circuit ‘ASIC’) configured to store and 4D wind buffer 322. In the example of FIG. 3, ground-based computing system 300 includes processing circuitry 310, memory 320, communication interface(s) 340, input device(s) 350, and output device(s). The aforementioned components of ground-based computing system 300 may be connected to one another through a bus 330, which generally represents one or more busses and is intended to generically represent all the electrical and data connectivity of internal components included within ground-based computing system 300.

Processing circuitry 310 implements the functionality of and/or executes the instructions associated with wind data extractor 324. Processing circuitry 310 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, ground-based computing system 300 may store instructions for the software in a suitable, non-transitory computer-readable medium (e.g., memory 320) and execute the instructions in hardware using processing circuitry 310 to perform the techniques of this disclosure.

Memory 320 is intended to generically represent all memory included within ground-based computing system 300. In some implementations, memory 320 may include a plurality of separate devices and memory units. These memory devices and memory units may include volatile memory, such as random access memory (RAM), and/or non-volatile memory, such as ROM and storage media. Example of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives). Wind data extractor 324 may be stored in any volatile and/or non-volatile memory component of memory 320 and executed by processing circuitry 310.

Memory 320 stores 4D wind buffer 322, which is used by ground-based computing system 300 to store 4D wind data. The 4D wind data may store wind speeds and wind directions associated with a latitude, a longitude, an altitude, and a time.

Communication interface(s) 340 generally represents some or all communication hardware, e.g., transceiver circuitry, within ground-based computing system 300 for communicating with external devices. Communication interface(s) 340 may facilitate communication with external devices via one or more wired and/or wireless network connections by transmitting and/or receiving signals on the one or more networks. Examples of communication interface(s) 340 include a network interface card (e.g., such as an Ethernet card or WiFi card), an optical transceiver, a radio frequency transceiver, or any other type of device that can send and/or receive information. Other examples of communication interface(s) 340 may include short wave radios, cellular data radios, wireless network radios, as well as USB controllers.

In the example of FIG. 3, ground-based computing system 300 also includes input device(s) 350 (e.g., a keyboard, mouse, or touchscreen) and output device(s) 360 (e.g., a display, printer, etc.). The various examples of input and output devices listed above represent a non-exhaustive list of the types of input and output devices that may be included in input device(s) 350 and output device(s) 360.

In accordance with the techniques of this disclosure, ground-based computing system 300 may be configured to receive, from a plurality of aircrafts, messages that include wind data detected by the aircraft at current locations of the aircraft. Ground-based computing system 300 may then update 4D wind buffer 322 based on the wind data detected by the plurality of aircraft at their respective locations. Ground-based computing system 300 may then receive, from another aircraft, flight plan data defining at least a portion of a flight path for the aircraft. In response to the flight path for the aircraft including locations for which 4D wind buffer 322 has 4D wind data, ground-based computing system 300, executing wind data extractor 324, may extract wind data from 4D wind buffer 322 for those locations and transmit the extracted wind data to the aircraft.

Although ground-based computing system 300 is shown in the example of FIG. 3 as being a single device, in many implementations, the functionality attributed to ground-based computing system 300 may be performed across multiple devices at multiple locations. For example, referring back to FIG. 2, ground-based computing system 300 may be distributed across ground station 206A and ground station 206B, as well as potentially other ground stations. From the perspective of aircraft 101, ground-based computing system 300 may be a cloud device or cloud system that provides aircraft 101 with cloud-based services.

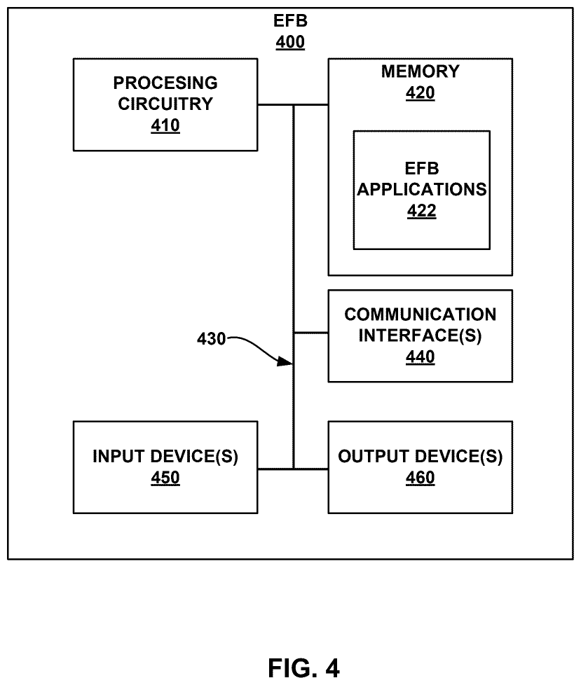

FIG. 4 is a block diagram illustrating an example of EFB 400. EFB 400 may include any sort of generic or application-specific computing hardware, such as a tablet computer, phone, laptop computer, desktop computer, a flight-management device, or other such computing device, that is configured to store and execute EFB applications. In other examples, EFB 400 may be specialized computing hardware configured to store and execute EFB applications. Some EFBs may be portable and be able to be carried from plane to plane, while other EFBs may be permanently mounted in a specific airplane. In the example of FIG. 4, EFB 400 includes processing circuitry 410, memory 420 which stores EFB applications 422, and communication interface(s) 440 to communicate with other devices.

Processing circuitry 410 implements the functionality of and/or executes the instructions associated with EFB applications 422. Processing circuitry 410 may be implemented as any of a variety of suitable circuitry that includes a processing system, such as one or more integrated circuits, microprocessors, DSPs, ASICs, FPGAs, discrete logic, software, hardware, firmware, or any combinations thereof. When the techniques are implemented partially in software, EFB 400 may store instructions for the software in a suitable, non-transitory computer-readable medium (e.g., memory 420) and execute the instructions in hardware using processing circuitry 410 to perform the techniques of this disclosure.

Memory 520 is intended to generically represent some or all memory included within EFB 400. In some implementations, memory 420 may include a plurality of separate devices and memory units. These memory devices and memory units may include volatile memory, such as RAM), and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned EFB application (shown in FIG. 4 as EFB applications 422) may be stored in any volatile and/or non-volatile memory component of memory 420.

EFB 400 also includes input device(s) 450 (e.g., a keyboard, mouse, or touchscreen) and output device(s) 460 (e.g., a display, printer). In implementations where EFB 400 is a phone or tablet computer, then the EFB may, for example, have a touchscreen and a display. In implementations where EFB 400 is a larger computer device, then the EFB may, for example, have a mouse, trackpad, keyboard, or other such input devices. The aforementioned components of EFB 400 may be connected to one another through a bus 430, which generally represents one or more busses and is intended to generically represent all the electrical and data connectivity of internal components included within EFB 400.

Communication interface(s) 440 generally represents some or all communication hardware, e.g., transceiver circuitry, within EFB 400 for communicating with external devices. Communication interface(s) 440 may facilitate communication with external devices via one or more wired and/or wireless network connections by transmitting and/or receiving signals on the one or more networks. Examples of communication interface(s) 440 include a network interface card (e.g., such as an Ethernet card), an optical transceiver, a radio frequency transceiver, a GPS receiver, or any other type of device that can send and/or receive information. Other examples of communication interface(s) 344 may include short wave radios, cellular data radios, wireless network radios, as well as universal serial bus (USB) controllers. In some examples, communication interface(s) 344 may include an avionics full-duplex switched ethernet (AFDX) interface, also known as ARINC 564.

EFB applications 422 may represent a suite of software tools that may be used by a pilot in managing flight operations. EFB applications 422 may include flight planning applications that allow pilots to create and file flight plans, access weather information, and calculate fuel requirements. EFB applications 422 may also include navigation applications that provide real-time navigation support with maps, airspace information, and waypoint management. EFB applications 422 may also include weather applications that provide real-time wind data, future weather predictions, radar imagery, and the like. EFB applications 422 may also include checklist applications for ensuring compliance with pre-flight, mid-flight, and post-flight procedures. EFB applications 422 may also include various performance analysis tools that, for example, help pilots compute takeoff and landing distances based on current conditions and aircraft configuration. EFB applications 422 may also include aircraft maintenance tracking tools that track aircraft maintenance schedules, inspection records, and compliance records. EFB applications 422 may also include flight logbooks that enable pilots to log flights, track hours, and generate reports for currency and certification. EFB applications 422 may also include airport information applications that provide information about airports, including runway layouts, services, and notices.

The various example applications listed above represent a non-exhaustive list of the types of applications that may be included in EFB applications 422. As explained above, some applications of EFB applications 422 may facilitate communication with avionics 500 using the data communication techniques of this disclosure.

In some examples, certain techniques described in this disclosure as being performed by avionics 500 may be performed at least in part by EFB 400. For example, EFB 400 may be configured to receive from avionics 500 current sensed wind data that was detected by wind sensors of avionics 500. EFB 400 may also receive, from a first external data source, forecast wind data for a first set of points along a flight path defined by the flight plan and transmit that forecast wind data to FMS 502. EFB 400 may also transmit at least a portion of the flight plan to a second external data source and in response to transmitting the at least the portion of the flight plan to the second external data source, receive from the second external data source ADS-B-acquired wind data for a second set of points along the flight path defined by the flight plan. EFB 400 may then transmit the ADS-B-acquired wind data for the second set of points to FMS 502 so that FMS 502 can control the aircraft to follow the flight path defined by the flight plan based on the current sensed wind data, the forecast wind data, and the ADS-B-acquired wind data.

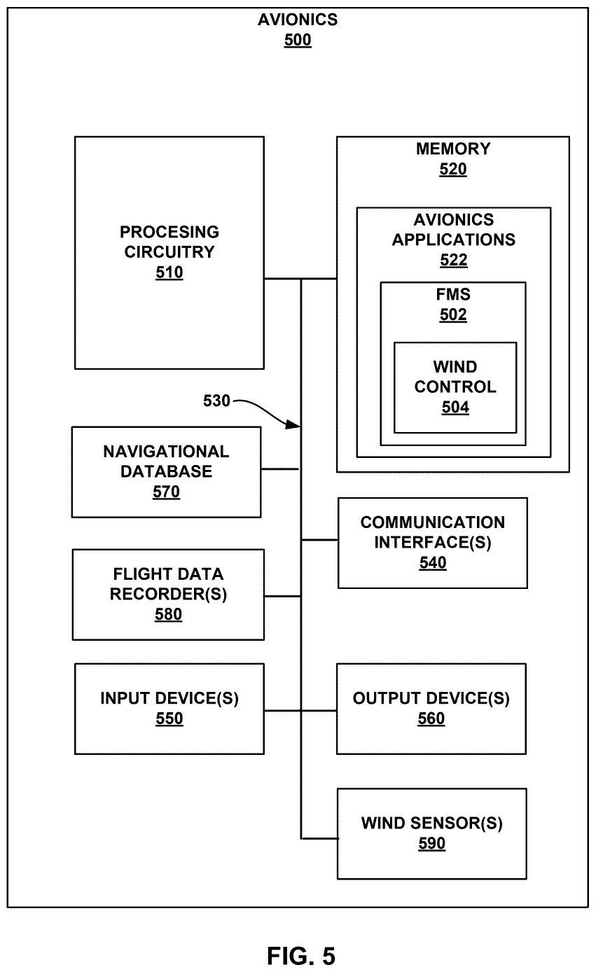

FIG. 5 is a block diagram illustrating an example of avionic 500. Avionics 500 may include specialized computing hardware configured to store and execute avionics applications. In the example of FIG. 5, avionics 500 includes processing circuitry 510, memory 520 which stores avionics applications 522, communication interface(s) 540 to communicate with other devices, such as EFB 400, input device(s) 550, output device(s) 560, navigational database 570, and flight data recorder(s) 580. The aforementioned components of avionics 500 may be connected to one another through a bus 530, which generally represents one or more busses and is intended to generically represent all the electrical and data connectivity of internal components included within avionics 500.

Processing circuitry 510 implements the functionality of and/or executes the instructions associated with avionics applications 522. Processing circuitry 510 may be implemented as any of a variety of suitable circuitry that includes a processing system, such as one or more integrated circuits, microprocessors, DSPs, ASICs, FPGAs, discrete logic, software, hardware, firmware or any combinations thereof. When the techniques are implemented partially in software, avionics 500 may store instructions for the software in a suitable, non-transitory computer-readable medium (e.g., memory 520) and execute the instructions in hardware using processing circuitry 510 to perform the techniques of this disclosure.

Memory 520 is intended to generically represent some or all memory included within avionics 500. In some implementations, memory 520 may include a plurality of separate devices and memory units. These memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 5 as avionics applications 522) may be stored in any volatile and/or non-volatile memory component of memory 520.

Communication interface(s) 540 generally represents some or all communication hardware e.g., transceiver circuitry, within avionics 500 for communicating with external devices either on the ground or while in flight. Communication interface(s) 540 may facilitate communication with external devices via one or more wired and/or wireless network connections by transmitting and/or receiving signals on the one or more networks. Examples of communication interface(s) 540 include a network interface card (e.g., such as an Ethernet card), an optical transceiver, a radio frequency transceiver, a GPS receiver, or any other type of device that can send and/or receive information. Other examples of communication interface(s) 540 may include short wave radios, cellular data radios, wireless network radios, as well as USB controllers. Examples of communication interface(s) 540 for in-flight communication include a very high frequency (VHF) radio, a high frequency (HF) radio, or a satellite communication (SATCOM) radio.

Examples of communication interface(s) 540 used for data links include ACARS for providing a digital data link system that allows for the exchange of messages between the aircraft and ground stations for purposes such as flight plan updates, weather information, and maintenance reports. Another examples of communication interface(s) 540 used for data links include controller-pilot data link communications (CPDLC) which allows air traffic control to send instructions and receive acknowledgments from pilots via text messages. Communications interface(s) 540 may also include an automatic dependent surveillance-broadcast transponder. The various examples of communications interfaces listed above represent a non-exhaustive list of the types of communication interfaces that may be included in communication interface(s) 540.

Avionics 500 also includes input device(s) 550 and output device(s) 560. Examples of input device(s) 550 include control display units (CDUs) with alphanumeric keypads or touchscreens to enter flight plans, waypoints, and other necessary data. Input device(s) 550 may also include an FMS control panel for entering information to the FMS, such as route, altitude, and speed using dedicated buttons, knobs, and touchscreen interfaces. Input device(s) 550 may also include yoke or sidestick controls as well as touchscreen interfaces. Input device(s) 550 may also include rotary knobs for setting values for altitudes, speeds, and other parameters and toggle switches for selecting modes or turning systems on and off.

Examples of output device(s) 560 may include an electronic flight instrument display to provide visual representations of flight data, including altitude, airspeed, heading, and attitude. Output device(s) 560 may also include a Heads-Up Display (HUD) that projects critical flight information onto a transparent screen in the pilot's line of sight or other cockpit displays to show navigation maps, engine parameters, system statuses, and the like. Output device(s) 560 may also include engine instrumentation displays to display data on engine performance, such as temperature, pressure, and revolutions per minute (RPMs). Output device(s) 560 may also include audio panels to relay communication from radios and alerts from systems to the cockpit. Output device(s) 560 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 550 and output device(s) 560. Additionally, input and output functionality of avionics 500 may be facilitated by external devices that are separate from input device(s) 550 and output device(s) 560. For example, EFB 400 may be configured to input data to and output data for avionics 500.

Avionics applications 522 may represent a suite of software tools that may be used by a pilot in managing flight operations and managing the aircraft while in flight. Avionics applications 522 includes FMS 502 discussed above as well as other applications for communication, navigation, and monitoring within an aircraft. Avionics applications 522, for example, include applications for processing and displaying weather radar data and presenting essential flight information such as altitude, airspeed, attitude, and heading to a pilot. Avionics applications 522 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 522 may also include the software to manage various emergency systems (e.g., an emergency locator transmitter, flight data recorder, and cockpit voice recorder) and cabin management systems (e.g., passenger infotainment systems and environmental control systems).

Navigational database 570 may represent a specialized database that stores information needed by FMS 502 for the navigation and operation of an aircraft for purposes such as flight planning, route management, and ensuring safe navigation throughout a flight. Navigational database 570 may, for example, store navigational data according to the ARINC 424 standard which specifies how navigation data, such as waypoints, airways, terminal procedures, and navigational aids, and other such data, is stored and transmitted.

Navigational database 570 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 570 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 570 may be regularly updated to reflect changes in air traffic regulations, airport information, and navigational aids to ensure pilots have current information for safe and efficient flight operations.

Although not explicitly shown in FIG. 5, avionics 500 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 500 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

In the example shown in FIG. 5, avionics 500 also includes one or more wind sensors 590 to measure and/or calculate wind speed and direction at a current location of the aircraft. Wind sensors 590 may, for example, include pitot tubes that measure dynamic pressure, representing the difference between the total pressure (ram air pressure) and static pressure. Based on these values processing circuitry 510 can calculate a true airspeed, which when compared to a ground speed and heading, as determined, for example, by an inertial reference system (IRS), can be used to determine a wind speed and direction. Wind sensors 590 may, for example, include an angle of attack (AoA) sensor to measure the angle between the aircraft's nose and the relative wind. Wind sensors 590 may also include weather radar and light detection and ranging (LIDAR) configured to determine wind vectors.

Flight data recorder(s) 580 may be configured to record, and store in memory 520, flight data 582. In some examples, flight data recorder(s) 580 may have dedicated memory, meaning the memory that stores flight data 582 is separate than, for example, the memory that stores avionics applications 522. Flight data recorder(s) 580 may include any combination of one or more flight data recorders including a quick access recorder, a deployable recorder, or a combined cockpit voice recorder and flight data recorder.

Flight data recorder(s) 580 may be configured to record flight dynamics and motion data. For example, flight data recorder(s) 580 may be configured to record the aircraft's altitude above sea level (i.e., altitude), the aircraft's speed relative to the surrounding air (i.e., airspeed), the aircraft's rate of ascent or descent (i.e., vertical speed), the direction the aircraft is pointed (i.e., heading), the aircraft's nose angle up/down and bank angle left/right (i.e., pitch and roll), the aircraft's deviation from a straight path or wind drift (i.e., yaw), and the aircraft's lateral, vertical, and longitudinal acceleration.

Flight data recorder(s) 580 may also be configured to record control surfaces and positioning data. For example, flight data recorder(s) 580 may be configured to record the aircraft's aileron position for controlling roll, the aircraft's elevator position for controlling pitch, the aircraft's rudder position for controlling yaw, the aircraft's flap positions for controlling changes in lift and drag (e.g., during takeoff, landing, and approach), the aircraft's spoiler positions for reducing lift and slowing the aircraft down, or the aircraft's slat positions for providing added lift during low-speed operations.

Flight data recorder(s) 580 may also be configured to record engine parameters. For example, flight data recorder(s) 580 may be configured to record the aircraft's engine output (e.g., engine thrust or power level), the aircraft engine's core and fan shaft speeds (i.e., N1 and N2 speeds), temperature of gases exiting the engine (e.g., exhaust gas temperature (EGT)), the rate at which fuel is consumed by each engine (i.e., fuel flow rate), oil Pressure, oil temperature, and thrust level set by the pilot (e.g., throttle position).

Flight data recorder(s) 580 may also be configured to record environmental conditions data. For example, flight data recorder(s) 580 may be configured to record outside air temperature, the presence of ice on wings or other critical surfaces, storm and weather information, and wind speed and direction.

Flight data recorder(s) 580 may also be configured to record aircraft systems and equipment data. For example, flight data recorder(s) 580 may be configured to record autopilot Status, such whether autopilot is engaged and what mode (altitude hold, heading mode, etc.) is being implemented. Flight data recorder(s) 580 may also be configured to record the position of the landing gear (e.g., up, down, or transit), brake pressure or braking force applied during landing, hydraulic pressure of braking systems, and cabin altitude and pressurization levels. Flight data recorder(s) 580 may also be configured to record electrical systems status, such as voltage, current, and operational state of systems.

Flight data recorder(s) 580 may also be configured to record flight path and navigation data, such as GPS position (e.g., latitude, longitude, and altitude coordinates), horizontal track and descent/ascent angles (i.e., flight path angle and track), speed relative to the ground (i.e., groundspeed), and navigation waypoints in the flight plan.

Flight data recorder(s) 580 may also be configured to record crew inputs. For example, flight data recorder(s) 580 may be configured to record control inputs, such as a pilot's inputs on yoke/stick, rudder pedals, and throttle. Flight data recorder(s) 580 may also be configured to record status or positions of switches (e.g., fuel pumps, anti-ice). Flight data recorder(s) 580 may also be configured to record communication controls, such as transponder codes, frequency changes, and communications status.

Flight data recorder(s) 580 may also be configured to record the status of warning and alarm systems, such as the status of alarms such as stall warnings, overspeed warnings, or terrain awareness warnings. Flight data recorder(s) 580 may also be configured to record engine and system alerts, such as malfunction notifications related to engine failures, low hydraulic pressures, or other such warnings. Flight data recorder(s) 580 may also be configured to record crew announcements and chimes.

FMS 502 may automate certain aspects of flight planning, navigation, performance management, and aircraft guidance to reduce pilot workload by optimizing and controlling various aspects of a flight. In some instances, FMS 502 may control autopilot functionality of the aircraft, whereas in other instances, FMS 502 may generate recommendations that require pilot approval prior to being implemented. Prior to takeoff, a pilot may input a flight plan into FMS 502, with the flight plan including waypoints, airways, altitude constraints, a destination, and other such information. Prior to takeoff as well as during flight, FMS 502 may also receive forecast wind data. During flight, FMS 502 may continuously update the aircraft's position using GPS, INS, and other systems and sensors. FMS 502 may, for example, optimize fuel consumption by adjusting power settings and altitude based on weight, wind conditions, and temperature. FMS 502 may also controls thrust to maintain speed during various flight phases, as well as generate roll commands to cause the aircraft to follow the programmed flight path (e.g., waypoints, airways), and generate pitch and power commands to maintain an optimal climb, cruise, and descent profile based on altitude constraints and fuel efficiency.

FMS 502 may, for example, include wind control module 504 to determine composite wind data based on the current sensed wind data, the forecast wind data, and the ADS-B acquired wind data and control an aircraft based on the composite wind. In some examples, the composite wind data may be only one of the current sensed wind data, the forecast wind data, or the ADS-B-acquired wind data. That is, the composite wind data may include a weighted average of the current sensed wind data, the forecast wind data, and the ADS-B-acquired wind data with two of the weights set to zero and one of the weights set to one. In other examples, the composite wind data may include a weighted average of the current sensed wind data, the forecast wind data, and the ADS-B-acquired wind data with two of the weights set to non-zero values and one of the weights set to zero. In other examples, the composite wind data may include a weighted average of the current sensed wind data, the forecast wind data, and the ADS-B-acquired wind data with all three of the weights set to non-zero values. In other examples, wind control module 504 may determine the composite wind data based on the current sensed wind data, the forecast wind data, and the ADS-B-acquired wind data in a non-linear manner.

In some examples, wind control module 504 may be configured to determine, for a location along the flight path, a weight to apply to the current sensed wind data based on a distance between the location along the fight path and a current location of the aircraft. If, for example, the location along the flight path is relatively close to the aircraft, then wind control module 504 may apply a weight of one to the current sensed wind data, such that the composite wind data is equal to the current sensed wind data. If, for example, the location along the flight path is relatively far from the aircraft, then wind control module 504 may apply a weight of zero to the current sensed wind data, such that the composite wind data is only based on one or both of the forecast wind data or the ADS-B acquired wind data.

In some examples, wind control module 504 may be configured to determine, for a location along the flight path, a weight to apply to the ADS-B acquired wind data based on a time associated with the ADS-B acquired wind data. If, for example, the ADS-B acquired wind data is current, then wind control module 504 may apply a weight of zero to the forecast wind data, such that the composite wind data is based only on the ADS-B acquired wind data or a combination of the ADS-B acquired wind data and the current sensed wind data. That is, when recent ADS-B-acquired wind data is available, then wind control module 504 may use the recent ADS-B acquired wind data instead of forecast wind data. If, on the other hand, the ADS-B acquired wind data is relatively old, then wind control module 504 may apply a weight of less than one or even a weight of zero to the ADS-B acquired wind data, such that the composite wind data is based only on the forecast wind data or a combination of the forecast wind data and the current sensed wind data. That is, when recent ADS-B-acquired wind data is not available, then wind control module 504 may rely less on the ADS-B acquired wind data.

In some example, if a location along the flight path is greater than a certain distance away, such as 200 nautical miles, and if current ADS-B-acquired wind data is available for the location, then wind control module 504 may be configured to rely exclusively on the ADS-B acquired wind data. That is, in such a situation, wind control module 504 may determine the composite wind data to be a weighted average of the current sensed wind data, the forecast wind data, and the ADS-B acquired wind data with the current sensed wind data and the forecast wind data each having a weighting of zero and the ADS-B acquired wind data having a weighting of one.

In some examples, wind control module 504 may be configured to use different weighting coefficients for forecast wind data and ADS-B acquired wind data relative to sensed wind data at a same distance. For instance, at 150 nautical miles away from the aircraft, if ADS-B acquired wind data is not available, then wind control module 504 may determine the composite wind data to be a weighted average of the current sensed wind data and the forecast wind data, with the current sensed wind data having a weighting of 0.25 and the forecast wind data having a weighting of 0.75. If, however, at 150 nautical miles away from the aircraft, ADS-B acquired wind data is available, then wind control module 504 may determine the composite wind data to be the ADS-B acquired wind data, i.e., a weighted average of the current sensed wind data and the ADS-B acquired wind data, with the current sensed wind data having a weighting of 0 and the forecast wind data having a weighting of 1.

Using the composite wind data, FMS 502 may be configured to adjust the aircraft's lateral (horizontal) and vertical (altitude) flight path to account for wind changes. For example, if headwinds are stronger than expected, e.g., as expected by initial forecast wind data, FMS 502 may determine a different altitude or course deviation to minimize fuel burn. FMS 502 may, for example, use the composite wind data to optimize airspeed settings to ensure the aircraft maintains an efficient ground speed. In cruise flight, for instance, FMS 502 may adjust thrust to compensate for headwinds or to take advantage of tailwinds while maintaining fuel efficiency.

Wind control module 504 may be configured to determine a wind correction and control autopilot functionality of the aircraft to implement the wind correction. FMS 502 may execute continuous wind corrections to maintain a correct flight path. For example, FMS 502 may adjust the aircraft's heading to counteract crosswinds and prevent drift from an intended course. If, for example, using the composite wind data, FMS 502 determines that strong headwinds are present in a portion of the flight path and may increase fuel burn, then FMS 502 may determine a more efficient altitude (step climb) or route change to avoid the headwinds before encountering the headwinds.

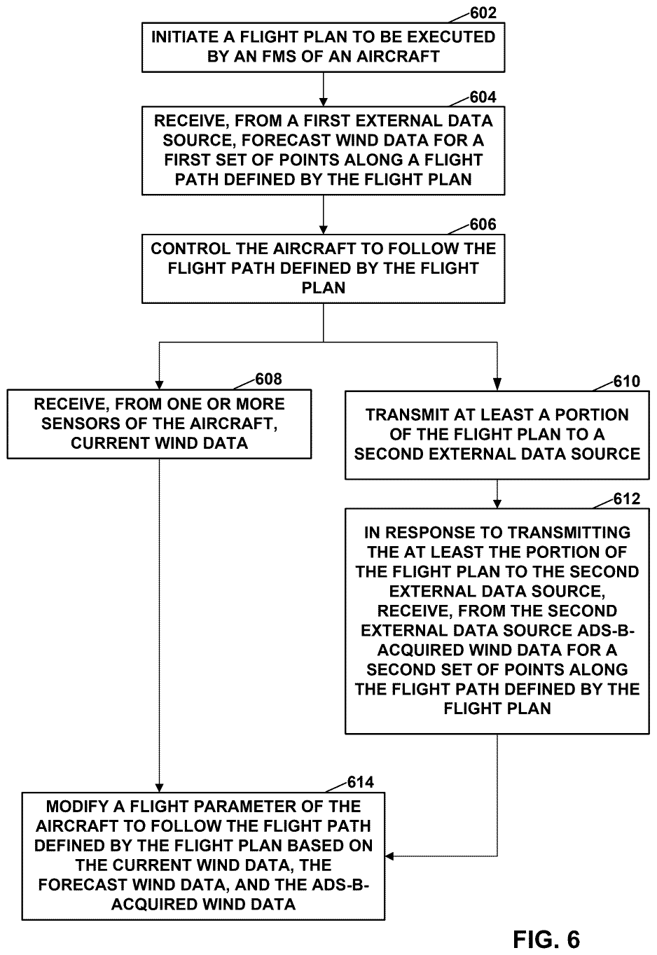

FIG. 6 is a flowchart illustrating a process for a computing system onboard an aircraft to control an FMS of an aircraft according to a flight plan. The techniques of FIG. 6 will be described with respect to a generic onboard computing system. The onboard computing system may, for example, be an EFB such as EFB 400, avionics such as avionics 500, or a combination of both an EFB and avionics.

In the example of FIG. 6, the onboard computing system initiates a flight plan to be executed by an FMS of an aircraft (602). The flight plan may, for example, be initiated by a pilot entering the flight plan directly into avionics that are controlling the FMS or via upload from a cloud-based device, EFB, or other such computing device. The flight plan may include a flight path, including a plurality of waypoints, that the aircraft is intended to follow.

The onboard computing system receives, from a first external data source, forecast wind data for a first set of points along a flight path defined by a flight plan (604). The forecast wind data may be either be transmitted electronically to the onboard computing system or may be manually entered by a pilot. The onboard computing system may, for example, receive the forecast wind data either before, during, or after the initiation of the flight plan. In some examples, the onboard computing system may receive initial forecast wind data prior to takeoff and then receive additional or updated forecast wind data during flight. In other examples, the onboard computing system may only receive forecast wind data prior to takeoff and may only receive the forecast wind data for the plurality of waypoints included in the flight plan. The first external data source may, for example, be a weather service that provides forecast wind data to aircraft.

An FMS of the onboard computing system controls the aircraft to follow the flight path defined by the flight plan data (606). While the FMS is controlling the aircraft to follow the flight path, onboard computing system may receive, from one or more sensors of the aircraft, current sensed wind data (608). While the FMS is controlling the aircraft to follow the flight path, the onboard computing system may also transmit at least a portion of the flight plan to a second external data source (610) and, in response to transmitting the at least the portion of the flight plan to the second external data source, receive, from the second external data source ADS-B-acquired wind data for a second set of points along the flight path defined by the flight plan (612). The second set of points along the flight path may be the same as, overlap with, or be different than the first set of points. The second external data source may, for example, be a cloud-based database that aggregates wind data received from a plurality of aircraft via ADS-B messages.

The onboard computing system may modify a flight parameter of the aircraft to follow the flight path defined by the flight plan based on the current sensed wind data, the forecast wind data, and the ADS-B-acquired wind data (614). For example, the FMS may determine a wind correction for the flight path based on the current sensed wind data, the forecast wind data, and ADS-B-acquired wind data and adjust one or both of an engine thrust or a heading of the aircraft based on the wind correction. In other examples, rather than modifying a flight parameter to cause the aircraft to follow the flight path, the onboard computing system may modify the flight path itself. For example, the onboard computing system may determine an alternate altitude or alternate trajectory based on the current sensed wind data, the forecast wind data, and ADS-B-acquired wind data.

Both the receiving of the current sensed wind data from the one or more sensors (e.g., step 608) and the receiving of the ADS-B-acquired wind data (e.g., step 612) may be near-continuous and/or near-real-time. That is, the current sensed wind data may be sensed and updated many times per hour or even multiple times per minute and may be used by the FMS to control the aircraft essentially immediately upon the current sensed wind data being determined. Similarly, ADS-B-acquired wind data may be received by the aircraft many times throughout the duration of a flight and may be used by the FMS to control the aircraft essentially immediately upon the ADS-B-acquired wind data being received.

In addition to receiving ADS-B-acquired wind data, the aircraft may also be configured to transmit current sensed wind data to the second external data source, such that other aircraft can receive ADS-B acquired wind data that includes the current sensed wind data of the aircraft.

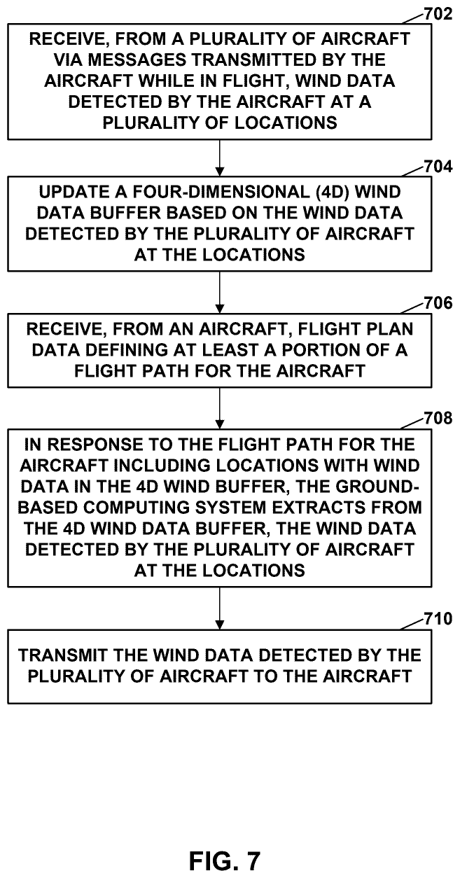

FIG. 7 is a flowchart illustrating a process for a ground-based computing system to acquire and transmit wind data to and from aircraft. The techniques of FIG. 7 will be described with respect to a generic ground-based computing system. The ground-based computing system may, for example, be ground-based computing system 300 or another system or set of systems.

In the example of FIG. 7, the ground-based computing system receives, from a plurality of aircraft via messages transmitted by the plurality of aircraft while in flight, wind data detected by the plurality of aircraft at a plurality of locations (702). The messages may, for example, be ADS-B messages. The ground-based computing system updates a 4D wind data buffer based on the wind data detected by the plurality of aircraft at the plurality of locations (704). The 4D wind data buffer stores wind directions and wind speeds associated with locations, as defined by a latitude, a longitude, and an altitude. The 4D wind data buffer may associate times with the wind directions and wind speeds. To update the 4D wind data buffer based on the wind data detected by the plurality of aircraft at the plurality of locations, the ground-based computing system may, for example, replace older wind directions and wind speeds with newer wind directions and wind speeds. In some examples, the wind speed and wind direction stored in the 4D wind buffer for a particular location may be an average of wind directions and wind speeds received from multiple aircraft for the location within a certain time window, e.g., an average of all wind speeds and wind directions received for the location within the last hour. ADS-B acquired wind data may differ from forecast wind data in that the ADS-B acquired wind data is equal to, or an average of, wind data directly sensed by aircraft at a specific location at a specific time and is not determined via forecasting or modelling.

The ground-based computing system receives, from an aircraft, flight plan data defining at least a portion of a flight path for the aircraft (706). In response to the flight path for the aircraft including locations with wind data in the 4D wind buffer, the ground-based computing system extracts from the 4D wind data buffer, the wind data detected by the plurality of aircraft at the locations (708). The locations along the flight path may include waypoints, as well as locations in between the waypoints. The ground-based computing system transmits the wind data detected by the plurality of aircraft for the locations to the aircraft (710).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method for controlling an FMS of an aircraft according to a flight plan, the method comprising:
determining, via one or more sensors of the aircraft, current sensed wind data;
receiving, from a first external data source by processing circuitry of avionics of the aircraft, forecast wind data for a first set of points along a flight path defined by the flight plan;
transmitting at least a portion of the flight plan to a second external data source;
in response to transmitting the at least the portion of the flight plan to the second external data source, receiving, from the second external data source, Automatic Dependent Surveillance-Broadcast (ADS-B)-acquired wind data for a second set of points along the flight path defined by the flight plan; and
controlling, by the processing circuitry of the avionics, the aircraft to follow the flight path defined by the flight plan based on the current sensed wind data, the forecast wind data, and the ADS-B-acquired wind data.

2. The method of claim 1, wherein ADS-B-acquired wind data comprises 4-dimensional wind data, wherein the 4-dimensional wind data includes a wind speed and a wind direction associated with a latitude, a longitude, an altitude, and a time.

3. The method of claim 1, wherein controlling, by the processing circuitry of the avionics, the aircraft to follow the flight path defined by the flight plan based on the current sensed wind data, the forecast wind data, and the ADS-B-acquired wind data comprises:
determining a wind correction for the flight path based on the ADS-B-acquired wind data; and
adjusting one or both of a thrust or a heading of the aircraft based on the wind correction.

4. The method of claim 1, wherein controlling, by the processing circuitry of the avionics, the aircraft to follow the flight path defined by the flight plan based on the current sensed wind data, the forecast wind data, and the ADS-B-acquired wind data comprises adjusting a thrust of an engine of the aircraft based on the current sensed wind data, the forecast wind data, and the ADS-B-acquired wind data.

5. The method of claim 1, wherein controlling, by the processing circuitry of the avionics, the aircraft to follow the flight path defined by the flight plan based on the current sensed wind data, the forecast wind data, and the ADS-B-acquired wind data comprises adjusting an altitude the aircraft based on the current sensed wind data, the forecast wind data, and the ADS-B-acquired wind data.

6. The method of claim 1, wherein controlling, by the processing circuitry of the avionics, the aircraft to follow the flight path defined by the flight plan based on the current sensed wind data, the forecast wind data, and the ADS-B-acquired wind data comprises:
determining a modification to the flight plan; and
in response to receiving a user input, modifying the flight plan in accordance with the determined modification.

7. The method of claim 1, wherein controlling, by the processing circuitry of the avionics, the aircraft to follow the flight path defined by the flight plan based on the current sensed wind data, the forecast wind data, and the ADS-B-acquired wind data comprises:
applying a weighting to each of the current sensed wind data, the forecast wind data, and the ADS-B-acquired wind data to determine composite wind data for a location along the flight path; and
controlling the aircraft to follow the flight path defined by the flight plan based on the composite wind data for the location along the flight path.

8. The method of claim 7, wherein applying the weighting to each of the current sensed wind data, the forecast wind data, and the ADS-B-acquired wind data to determine the composite wind data for the location along the flight path comprises applying a weighting of zero to the forecast wind data in response to a time associated with the ADS-B-acquired wind data being more recent than a time associated with the forecast wind data.

9. The method of claim 7, wherein applying the weighting to each of the current sensed wind data, the forecast wind data, and the ADS-B-acquired wind data to determine the composite wind data comprises:
applying a first weighting of zero to the ADS-B-acquired wind data in response to the ADS-B-acquired wind data not including data for the location along the flight path; and
applying a second weighting of zero to the current sensed wind data in response to the location along the flight path being more than a threshold distance away from a current location of the aircraft.

10. The method of claim 1, further comprising:
transmitting the current sensed wind data in an ADS-B message to the second external data source.

11. A computing system onboard an aircraft, the computing system comprising:
a memory; and
one or more processors coupled to the memory and configured to:
receive, from one or more sensors of the aircraft, current sensed wind data;
receive, from a first external data source, forecast wind data for a first set of points along a flight path defined by a flight plan;
transmit at least a portion of the flight plan to a second external data source;
in response to transmitting the at least the portion of the flight plan to the second external data source, receive, from the second external data source Automatic Dependent Surveillance-Broadcast (ADS-B)-acquired wind data for a second set of points along the flight path defined by the flight plan; and
control the aircraft to follow the flight path defined by the flight plan based on the current sensed wind data, the forecast wind data, and the ADS-B-acquired wind data.

12. The computing system of claim 11, wherein ADS-B-acquired wind data comprises 4-dimensional wind data, wherein the 4-dimensional wind data includes a wind speed and a wind direction associated with a latitude, a longitude, an altitude, and a time.

13. The computing system of claim 11, wherein to control the aircraft to follow the flight path defined by the flight plan based on the current sensed wind data, the forecast wind data, and the ADS-B-acquired wind data, the one or more processors are configured to:
determine a wind correction for the flight path based on the ADS-B-acquired wind data; and
adjust one or both of a thrust or a heading of the aircraft based on the wind correction.

14. The computing system of claim 11, wherein to control the aircraft to follow the flight path defined by the flight plan based on the current sensed wind data, the forecast wind data, and the ADS-B-acquired wind data, the one or more processors are configured to adjust a thrust of an engine of the aircraft based on the current sensed wind data, the forecast wind data, and the ADS-B-acquired wind data.

15. The computing system of claim 11, wherein to control the aircraft to follow the flight path defined by the flight plan based on the current sensed wind data, the forecast wind data, and the ADS-B-acquired wind data, the one or more processors are configured to adjust an altitude the aircraft based on the current sensed wind data, the forecast wind data, and the ADS-B-acquired wind data.

16. The computing system of claim 11, wherein to control the aircraft to follow the flight path defined by the flight plan based on the current sensed wind data, the forecast wind data, and the ADS-B-acquired wind data, the one or more processors are configured to:
determine a modification to the flight plan; and
in response to receiving a user input, modify the flight plan in accordance with the determined modification.

17. The computing system of claim 11, wherein to control the aircraft to follow the flight path defined by the flight plan based on the current sensed wind data, the forecast wind data, and the ADS-B-acquired wind data, the one or more processors are configured to:
apply a weighting to each of the current sensed wind data, the forecast wind data, and the ADS-B-acquired wind data to determine composite wind data for a location along the flight path; and
control the aircraft to follow the flight path defined by the flight plan based on the composite wind data for the location along the flight path.

18. The computing system of claim 17, wherein to apply the weighting to each of the current sensed wind data, the forecast wind data, and the ADS-B-acquired wind data to determine the composite wind data for the location along the flight path, the one or more processors are configured to apply a weighting of zero to the forecast wind data in response to a time associated with the ADS-B-acquired wind data being more recent than a time associated with the forecast wind data.

19. The computing system of claim 17, wherein to apply the weighting to each of the current sensed wind data, the forecast wind data, and the ADS-B-acquired wind data to determine the composite wind data, the one or more processors are configured to:
apply a first weighting of zero to the ADS-B-acquired wind data in response to the ADS-B-acquired wind data not including data for the location along the flight path; and
apply a second weighting of zero to the current sensed wind data in response to the location along the flight path being more than a threshold distance away from a current location of the aircraft.

20. The computing system of claim 11, wherein the one or more processors are configured to:
transmit the current sensed wind data in an ADS-B message to the second external data source.
